(19) United States
(12) Patent Application Publication
(10) Pub. No.: US 2019/0039262 A1
(43) Pub. Date: Feb. 7, 2019

(54) HOLE SAWS

(71) Applicant: Kyle Gamble, Hertfordshire (GB)

(72) Inventor: Kyle Gamble, Hertfordshire (GB)

(21) Appl. No.: 15/831,344

(22) Filed: Dec. 4, 2017

Related U.S. Application Data
(63) Continuation of application No. PCT/GB2016/000112, filed on Jun. 3, 2016.

(51) Int. Cl. B28D 1/04; B23B 51/04

(52) U.S. Cl. CPC B28D 1/041; B23B 51/0473; B23B 51/0426

(57) ABSTRACT

The present invention seeks to provide a simple, easily realisable and inexpensive solution to the problems discussed above. The present invention further seeks to provide a hole-saw device which enables rapid changes of hole saw. The present invention also seeks to provide a simple device for enlarging apertures which is simple, cost effective and can be used with standard drills of corded and battery types as well as manual types.

### CROSS-REFERENCE TO RELATED APPLICATIONS

This application claims priority to PCT application serial number PCT/GB2016/000112, titled “Hole Saw”, which was filed on Jun. 3, 2016, the entire specification of which is incorporated herein by reference in its entirety.

### BACKGROUND

### Field of the Art

The disclosure relates to the field of hole cutting in general, and more particularly to the field of creation and the enlargement of holes and the like in plasterboard, plywood, plaster walls and the like.

### Discussion of the State of the Art

The use of rotary drill tools such as hand-drills and mains or battery powered machine drills is ubiquitous in the building trade whether for maintenance or original build, by carpenter, electrician, gas-engineer or plumber. Equally most homes have a number of drill-drivers for Do-It-Yourself (DIY) projects hobbies or otherwise. Typically, a DIY drill-driver for home will be provided with a set of drill bits which are cutting tools used to create cylindrical holes, almost always of circular cross-section. Drill bits come in many sizes and have many uses. Bits are usually connected to a mechanism, often simply referred to as a drill, which rotates them and provides torque and axial force to create the hole. The shank is the part of the drill bit grasped by the chuck of a drill. The cutting edges of the drill bit are at one end, and the shank is at the other. Whilst the term “drill” may refer to either a drilling machine or a twist-drill/spade drill bit for use in a drilling machine, for the purposes of clarity in this specification, twist drill bits, spade drill bit, drill bit or bit is used throughout to refer to a bit for use in a drilling machine, and drill refers always to a drilling machine.

Twist drill bits tend to be employed up to 12 mm (½″) for materials such as metal, plaster and wood, but they tend to chip wood out at the entry and exit of the hole. Spade drill bits are frequently used for rough boring in wood. In some cases, as in rough holes for carpentry, the quality of the hole does not matter, and a number of drill bits for fast cutting in wood exist, including spade drill bits and self-feeding auger drill bits. Plaster walls consist of several thick layers of cement-like plaster over a wood lathe frame. Spade drill bits have a flat distal end in alignment with an axis of rotation, with a centering point and two cutters. Spade drill bits are ordinarily available in diameters from 6 to 36 mm (0.24″ to 1.42″).

A hole saw, also known as a hole cutter, is a saw blade having an annular (ring) shape, whose annular kerf creates a hole in the work-piece without having to cut up the core material. It is used with a drill. The depth to which a hole saw can cut is limited by the depth of its cup-like shape. Most hole saws have a fairly short aspect ratio of diameter to depth, and they are used to cut through relatively thin work-pieces. However, longer aspect ratios are available for applications that warrant a greater depth of cut, noting that friction issues may arise, since the drill is more often than not hand-held and it is normal for a hole saw to wander off-axis to a degree, noting that a not inconsiderable axial force can be applied, whether through necessity e.g. the drill is not sufficiently powerful or the hole saw teeth are not as sharp as they should be, the work-piece being cut is a difficult substance or the workman employing the drill believes that the cut will be faster.

Hole saws typically have a pilot twist-drill bit at their center to keep the hole saw centralized, to prevent the saw teeth from moving from the intended place of cutting or “from walking”, as is commonly said. After the first few millimeters of cut, the centering mechanism may no longer be needed, although it will help the hole saw to bore without wandering in a deep hole. In order to allow kerf to be removed, the cylinder wall is provided with sloping slots in the cylinder wall to help carry the dust out and to enable radial access to the twist-drill bit mechanism. The kerf of the cut is designed to be slightly larger than the diameter of the rest of the hole saw so that it does not get jammed in the hole. The fact that a hole saw creates the hole without needing to cut up the core often makes it preferable to use over twist-drill bits or spade drill bits for relatively large holes (especially those larger than 25 millimeters (1.0 inch)). The same hole can be made faster with the use of less power; less mess is created.

A problem exists, on the one hand that it is difficult and/or clumsy and/or time consuming to change a hole saw bit. On the other hand, especially in the case of the enlargement of holes, a pre-existing hole may prevent placement of a central twist-drill bit. This situation can occur in a number of situations, for example, in the case where light fittings, such as down-lighters, with bodies that are inserted within a wall or ceiling of a known diameter with are to be replaced with light fixtures having bodies of a second diameter, the wall or ceiling requiring an enlarged circular recess. Similar situations will exist with the replacement of pipes, which pipes extend between rooms, where the later pipes are larger and the holes need to be merely enlarged.

There are two widely used methods of enlarging a known hole using a drilling machine. A step drill bit is a drill bit that has a series of widths from a small, ground tip thereof. The step drill bits are made for sheet metal each step typically being 4 mm (⅛″) and therefore if one were to use such a type of drill bit to enlarge a plaster hole, there would be a tremendous mess since all the plaster cut-out (or plywood, etc.) would be converted to dust, although the step drill bits tend not to walk in use. However, this type of drill bit—as its name suggests—provides a plurality of gradually enlarging holes, which benefit from the fact that the various diameters tend to have the same flute characteristics, which keeps the bit from clogging when drilling in soft materials, such as aluminum; but this is of any benefit in only a few applications.

U.S. Pat. No. 7,850,405 provides a hole saw boss including a threaded member adapted to accommodate two hole saws of different hole saw diameters. This teaching allows for a pre-existing aperture in a work piece to be simply enlarged. The hole saw boss is provided with at least a first and second threaded portion; said first threaded portion being adapted to engage a threaded bore of a first hole saw; and said second threaded portion being adapted to engage a threaded bore of a second hole saw. However, this system is simple in that the inner hole saw is also a circular saw, which means that not only does the guide have cutting teeth but that contact of the inner hole saw with an inside edge of the hole—which will inevitably happen—will result in the generation of vibrations and, when the hole is finished liable to damage an inside surface (possibly a rafter, for example. A further hole saw is taught in U.S. Pat. No. 5,624,213, in that it provides a two-hole arbor cutting arrangement, with an optional third pilot hole facility. Again, this teaching suffers from increasing the size of the original hole into which the inner hole saw is projected into. U.S. Pat. No. 5,413,437 teaches of a double-sided hole saw wherein first and second reversely directed arbors are conjoined by a fastening pin. In the alternative, a double-length arbor is utilized. In either case, the arbor is too long for many jobs that would wish to be performed by an electrician, plumber or general handyman. Additionally, the extra length may cause the tool to become dangerous in use, since, for example, wires within or behind plaster or plasterboard could be grabbed and coiled around the shaft of the extended arbor.

### SUMMARY

Accordingly, the inventor has conceived and reduced to practice, a simple, easily realizable and inexpensive solution to the problems discussed above. The present invention further seeks to provide a hole-saw device which enables rapid changes of hole saw. The present invention also seeks to provide a simple device for enlarging apertures which is simple, cost effective and can be used with standard drills of corded and battery types as well as manual types.

According to one aspect, a rotary hole saw for the creation of a hole in a work-piece, the tool comprising: a generally cylindrical boss having a shaft at a proximal end for fitment to a chuck of a drill tool and rotation therewith about a central axis; a hole saw for cutting a substantially circular hole in a work-piece; wherein the boss comprises a mandrel and a screw-threaded portion, wherein the mandrel is operable to axially slide between a proximal release position and a distal locking position, between the proximal end and the screw-threaded portion at a distal end of the boss, the mandrel having at least one elongate member extending in a distal direction coaxial with the central axis; wherein the hole-saw element comprises a generally cup-shaped cutting element, having a base and a circularly cylindrical annular wall element extending therefrom with a distal edge at a distance L1 from the base, wherein the base has a central screw-threaded portion for coupling with the boss and at least one aperture through which the said at least one elongate member of the mandrel can extend; the mandrel having a bias to the distal locking position, such that once the hole saw is screw-threadedly associated with the boss and the mandrel faces the base of the hole saw and the said at least one elongate member of the mandrel extends into the bases of the hole saw the boss and the hole saw become axially and radially fixed with respect to each other, is disclosed.

The present invention thus provides an additional tool to be employed in a set of tools for the creation of a hole, whereby to enable a simple and rapid change of diameter of hole saw as is appropriate for a particular task or set of tasks and which tool enables the use of less costly pressed steel hole saw to be used (i.e. without, necessarily, employing the use of a threaded bushing)—that is to say it has been found that the hole saw, using industry standard threads, can provide axial securement, with the radially-fixed mandrel preventing radial movement of the hole saw. Surprisingly, it has been found that with hole saws having a base made from pressed steel, which is tapped with an appropriate thread, can provide a secure yet easily fitted hole saw. By engaging the screw-threaded element of the boss, axial movement is constrained with respect to each of the hole saw element and the guide element; the engagement of the axial member associated with the mandrel which slides in an axial direction with respect to the boss and is radially fixed, so that when the elongate members locate with the bases of the hole saw and the guide member, the hole saw and the guide member become axially and radially fixed. Preferably, the mandrel abuts the base of the hole saw, but it has been found that this is not absolutely necessary. The mandrel may be prevented from moving by reason of friction, a detent system such that a ball-bearing or similar spring-loaded member engages with a co-operating engagement feature, or the mandrel may be resiliently biased into a locking position, with the mandrel being pulled towards the proximal part of the boss to enable the elongate members to be removed and the hole saw element to be removed.

According to another aspect, a rotary hole saw for the enlargement of a pre-existing hole in a work-piece, the tool comprising: a generally cylindrical boss having a shaft at a proximal end for fitment to a chuck of a drill tool and rotation therewith about a central axis; a hole saw for cutting a substantially circular hole in a work-piece; and, a guide element; wherein the boss comprises a mandrel and a screw-threaded portion, wherein the mandrel is operable to axially slide between a proximal release position and a distal locking position, between the proximal end and the screw-threaded portion at a distal end of the boss, the mandrel having at least one elongate member extending in a distal direction coaxial with the central axis; wherein the hole-saw element comprises a generally cup-shaped cutting element, having a base and a circularly cylindrical annular wall element extending therefrom with a distal edge at a distance L1 from the base, wherein the base has a central screw-threaded portion for coupling with the boss and at least one aperture through which the said at least one elongate member of the mandrel can extend; wherein the guide element has a base and a circularly cylindrical annular wall element, wherein the base has a central screw-threaded portion for coupling with the boss and at least one aperture through which the said at least one member of the mandrel can extend, the annular wall element having a distal edge arranged at a distance L2 from the boss, wherein in use, the guide element can be inserted into the pre-existing hole to provide support in centralizing the rotary saw therewith, the guide element extending a distance L2−L1, beyond the hole saw; the mandrel having a bias to the distal locking position, such that when the hole saw and the guide are screw-threadedly associated with the boss, the mandrel faces the bases of the hole saw and the guide and the said at least one elongate member of the mandrel extends into the bases of the hole saw and the guide whereby to axially and radially fix the same with respect to the boss, is disclosed.

The present invention thus provides an additional tool to be employed in a set of tools for increasing the size of a hole, whereby to assist in the provision of an improved finish by virtue, for example, by providing a stable guide element, overcoming an issue of having no support—which can be dangerous and inaccurate—or overcoming an issue of using a smaller hole saw which is liable to vibrate in use by virtue of their swarf apertures and reduce the chance of damage by virtue of an inner saw not visible in operation, which protrudes beyond the visible, outer larger diameter hole saw tool. By engaging the screw-threaded element of the boss, axial movement is constrained with respect to each of the hole saw element and the guide element; the engagement of the axial member associated with the mandrel which slides in an axial direction with respect to the boss and is radially fixed, so that when the elongate members locate with the bases of the hole saw and the guide member, the hole saw and the guide member become axially and radially fixed. The mandrel may be prevented from moving by reason of friction, a detent system such that a ball-bearing or similar spring-loaded member engages with a co-operating engagement feature, or the mandrel may be resiliently biased into a locking position, with the mandrel being pulled towards the proximal part of the boss to enable the elongate members to be removed and the hole saw element and the guide element to be removed. This can be done simply an intuitively. Furthermore, inventor has found that, once the hole saw element has become engaged on the screw-thread and provided guide element have engaged with the screw-thread for approximately at least a couple of turns, the exact position of the respective hole saw and guide elements is not material to the successful coupling of the respect parts, providing an ease of assembly, that is not normally associated with the assembly of such tools.

Conveniently, the mandrel is provided with two outwardly extending elongate members, which locate and abut with respect to two apertures associated with the bases of the of the hole saw and the guide. Such spigots locate and abut with respect to two apertures with the base of the hole saw element, whereby to prevent slippage in use. By the provision of two, diametrically arranged spigots, then balance can be retained in use; in the alternative, three or more (n) elongate (spigot) members may be provided, the spigot members being spatially separated by 360/no from each other. Conveniently, but not necessarily, the base of the hole saw abuts the mandrel. Applicants have determined that while the hole saw is ideally rotated such that it is placed as close to the mandrel as is possible, provided that the thread of the hole saw is fully engaged, the mandrel may be slid toward the hole saw base so that the elongated elements are located within the aperture of the hole saw as far as possible, thereby providing a sufficient thickness of material for the base wall, then a couple of turns of internal thread can be defined within the base wall enabling the hole saw to be securely and concentrically held with respect to the boss, the elongate or spigot members merely ensuring the relative rotational position. Conveniently, where employed, the guide element is also similarly equipped with a base having a number of turns of thread in the internally threaded member.

A specific advantage is that neither the hole saw element nor the guide need to be placed in any one position; provided that the hole saw and guide element have sufficiently engaged the screw threaded member of the boss, the elongate element of the mandrel can be inserted into aligned apertures. That is to say the guide element does not need to be screw-threadingly tightened with respect to either of the boss or the hole saw element. As is known with the prior art, when screw-threaded elements are fastened in a chuck arrangement that is subject to tightening and to heat cycles in use, then the elements—in particular the guide elements can be very difficult to be removed. By the use of the present invention, such problems are not encountered. Indeed, the system of attachment can be such that there are a number of positions that the hole saw can be fastened relative to the axial screw-thread of the boss. Furthermore, when the hole saw has been attached, there is a degree of variation that the guide element can be placed. If there are two diametrically spaced apart elongate elements or spigots, then guide element can be placed in a number of positions relative to the hole saw, even if a face of the mandrel is abutting a wall of the hole saw. Accordingly, the present invention allows the drill system to be secure even though not necessarily being placed in the same position each time it is used.

Most parts of the tool can be fabricated form tool steel, as is known; the hole saw can at least have a base made form an easily pressed steel, with hardened teeth formed after pressing through techniques that are known or by welding distinct cutting steel to the distal parts of the hole saw whereby to provide hardened teeth. The guide element can be fabricated from an engineering plastics material, as one of a molded or machined element. Conveniently, in the event that the guide element is manufactured from a plastics material, it has a centrally placed metallic insert having an internal screw-thread. The guide element can be fabricated as a pressed steel element. The guide element can be a generally cup-shaped element. Equally, the guide element can comprise a solid element, such as a low-friction plastics material, conveniently with axial holes defined therein to reduce the overall weight of the guide element. A distal edge of the guide element may be provided with a serrated element whereby to assist in the removal of debris associate with an aperture.

The rotary hole saw can be arranged such that the distal end of the boss is provided with an aperture for placement of a guide drill bit. There can be provided a radially directed internally threaded aperture and a screw-threaded member, whereby to enable securement of a drill bit therein. Preferably the hole saw has a low friction paint is applied to at least one of an outside surface the hole saw and an outside surface of the guide element.

The guide element can have a slight frusto-conical shape, reducing in diameter at a distal end with respect to the boss, this can make it easier to remove debris removed upon use of the hole saw. In a still further embodiment, a distal portion of the guide element is mounted for rotation with respect to the base of the guide element.

It has been found that certain benefits can arise in the event that the guide element has a slight frusto-conical shape, reducing in diameter at a distal end with respect to the boss, whereby an annular element defined by the cutting process can engage with the guide, to reduce creation of debris. It has also been found that further benefits arise when the distal portion of the guide element is mounted for rotation with respect to the base of the guide element. This can either stop or reduce any tendency for the guide element to snag or otherwise cause the hole saw to wander. Independently or additionally to this rotational feature of the distal end, the guide element can be resiliently mounted for a telescopic reduction in length, whereby in the event that the guide cannot progress with in a pre-defined aperture, the hole saw can still proceed into the work-piece. The hole saw can be arranged such that there is further provided a twist drill element that can be operably fastened by a chuck element having a base, wherein the chuck element base has an internally threaded aperture and at least one aperture through which the said at least one member of the mandrel can extend, whereby to secure the twist drill element in place of the guide element. By the provision of a range of hole saw diameters, guide element diameters and, conveniently, provision for a pilot drill bit, a simple to use system can readily be provided to create holes and to enable simple enlargement of holes and apertures with a tool that is not too different from tools presently employed by builders, electricians and other like tradesmen.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 shows a perspective view of a known hole saw.

FIG. 2 shows a perspective view of a first embodiment of the invention.

FIG. 3A shows a perspective view of a boss in accordance with the invention

FIG. 3B shows a side view of a boss in accordance with the invention.

FIG. 4A shows a side view of a boss with hole saw and guide elements in spaced apart fashion.

FIG. 4B shows another side view of a boss with hole saw and guide elements in spaced apart fashion.

FIG. 5A shows a plan view of the invention.

FIG. 5B shows another plan view of the invention.

FIG. 5C shows another plan view of the invention.

FIG. 5D shows a perspective view of the invention.

FIG. 6A shows a side view of a boss.

FIG. 6B shows another side view of a boss.

FIG. 7 shows an embodiment of the invention in spaced-apart fashion.

FIG. 8A shows an embodiment of the invention.

FIG. 8B shows a further embodiment of the invention.

FIG. 9A shows a view of an embodiment of the invention, detailing operation.

FIG. 9B shows another view of an embodiment of the invention, detailing operation.

FIG. 9C shows another view of an embodiment of the invention, detailing operation.

FIG. 9D shows another view of an embodiment of the invention, detailing operation.

FIG. 9E shows another view of an embodiment of the invention, detailing operation.

FIG. 10 shows a hole saw and two guide elements in perspective, dis-assembled views.

FIG. 11A shows a boss in a pre-engagement mode.

FIG. 11B shows a boss with a hole saw in an engagement mode.

FIG. 11C shows a boss with optional central drill bit in position.

FIG. 12A shows another embodiment of the invention.

FIG. 12B shows another embodiment of the invention.

FIG. 12C shows another embodiment of the invention.

FIG. 12D shows another embodiment of the invention.

FIG. 12E shows the arrangement of a specific embodiment.

FIG. 13A shows how a guide element engages with a mandrel.

FIG. 13B shows how a guide element engages with a mandrel.

FIG. 13C shows how a guide element engages with a mandrel.

FIG. 13D shows how a guide element need not be fully screwed-in with respect to the arbor, yet remains securely fastened.

FIG. 14 shows a simple range of products that can be available in accordance with the invention.

### DETAILED DESCRIPTION

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific.

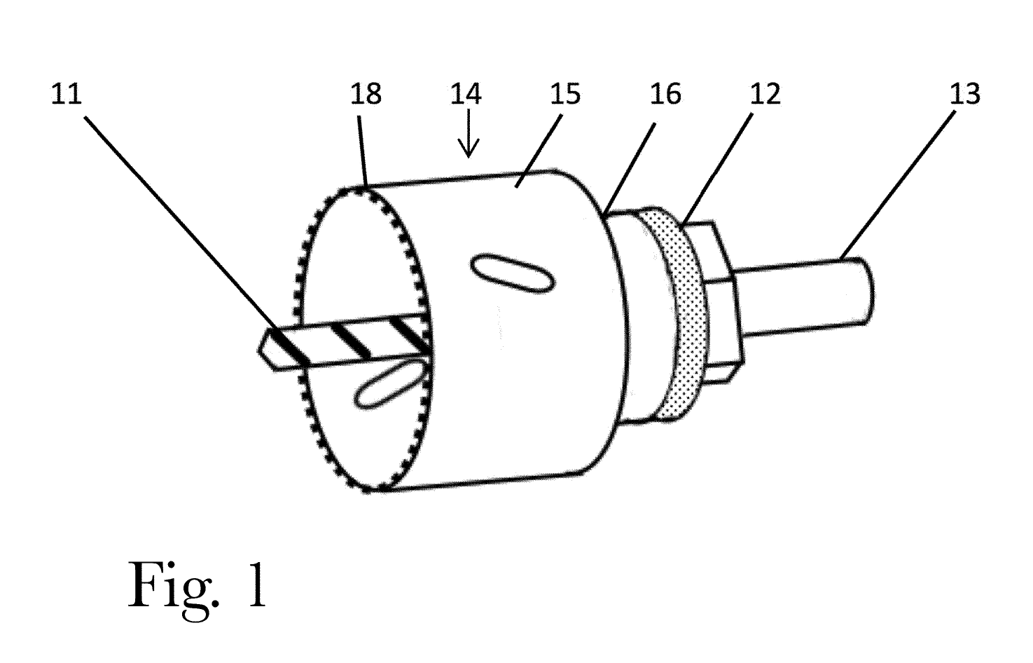

FIG. 1 shows a perspective view of a known hole saw, showing a central twist-drill bit 11 mounted upon a boss 12 having a shaft 13 for fitment to a chuck of a drill. A hole saw element 14 comprising a general circular bucket shape, with parallel walls 15 and a base 16. The base is provided with a bore (not shown) to allow passage of an externally threaded portion of the boss 12 (not shown) and fastened to the boss by way of a screw-fastening element (also not shown). The base is conveniently formed from tool-grade steel which can be formed by pressing, together with teeth 18, which can be formed and then hardened. In the alternative, the hole saw element can be manufactured from two types of steel, the first type being capable of easily press-formed, the upstanding walls of which are welded to harder steel to enable the teeth to remain sharp, the diameter of the annular wall corresponds in size to the size of a desired hole. The walls of the hole saw are provided with diagonal slots, whereby to assist in the removal of swarf and to enable cooler operation of the saw.

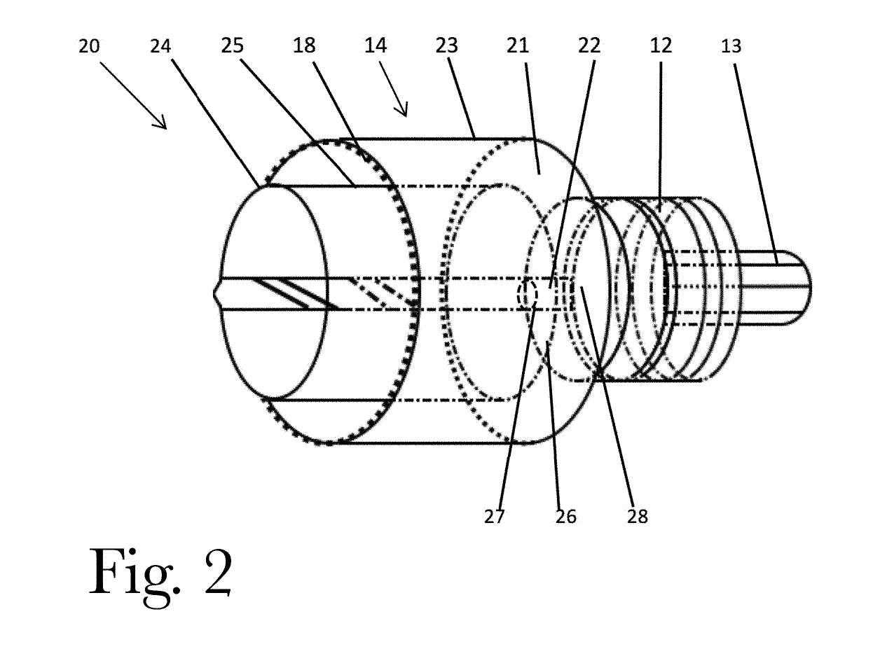

Referring now to FIG. 2, there is shown a first embodiment of a hole saw 20 in accordance with the invention, shown in perspective view. This embodiment details not only a hole saw but also a guide, as employed to enlarge an existing hole, to enable the full utility of the invention to be explained simply and in detail, noting that both FIGS. 1 and 2 show a twist drill 11 as employed to steady the hole saw, when in use. The hole saw 20 has a shaft 13 for insertion and fastening with respect to the chuck of a rotary tool, as is known. A mandrel 12 is provided which is slidably mounted upon the shaft. The mandrel 12 is provided with a resilient element such as a coil spring (not shown) such that in its rest position it is as far away from the proximal shaft portion as is possible and the mandrel 12 is urged against the force of the resilient element as the hole saw element 14 is rotated towards the proximal end; the hole saw being fastened when the elongate members can be inserted within the apertures of the base of the hole saw. Ideally, the hole saw is rotated along the screw-thread such that the base of the hole saw abuts the distal face of the mandrel, but it has been found that it is not strictly necessary for the hole saw to be maximally threaded onto the boss, although it will be appreciated that the further the hole saw is threaded onto the boss, the greater amount of screw-thread is available for any subsequent guide to be placed upon the boss if one is enlarging a pre-existing hole. Mounted upon the boss is a hole saw 14, of a general open tin can shape, comprising a base 21 with a screw-threaded bore 22 defined therethrough and having an annular wall 23 depending from the base, with a distal portion terminating with teeth 18, the diameter of the annular wall corresponds in size to the size of a desired hole. The invention provides a further element, a guide element 24, also corresponding to a general open tin can shape, but which guide element is provided neither with teeth nor any apertures for swarf removal associated with its annular wall 25, which annular wall depends from a base 26 having a bore 27 whereby the guide element can fit about a threaded shaft 28 extending distally from the boss with respect to the input shaft, the diameter of the annular wall corresponding to the size of a prior hole. Conveniently, a low friction paint, such as a Teflon® paint, is applied to an outside surface of the inner annular wall, whereby to ensure that the tool is not urged off axis in use. With regard to manufacture of the boss and components, especially the spigots or elongate elements, tool steel is employed—tool steel, as is known, being the term used to cover a variety of carbon and alloy steels that are particularly well-suited to be made into tools, arising from their hardness, resistance to abrasion and deformation and their ability to hold a cutting edge at elevated temperatures.

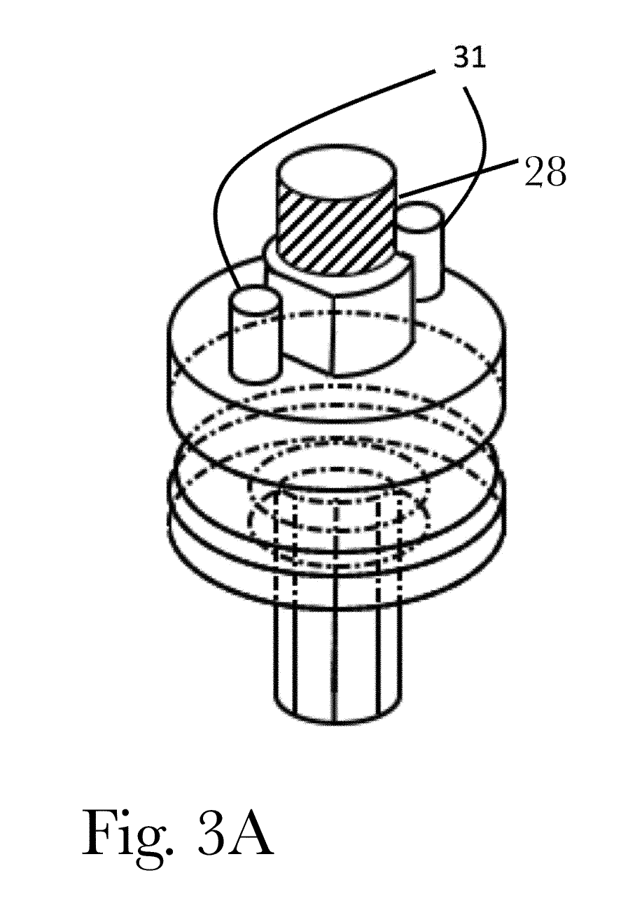

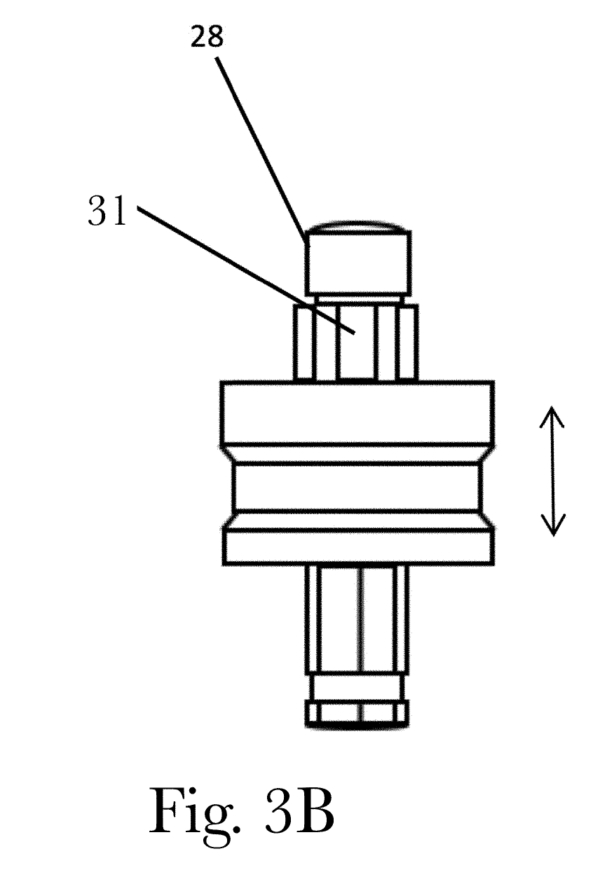

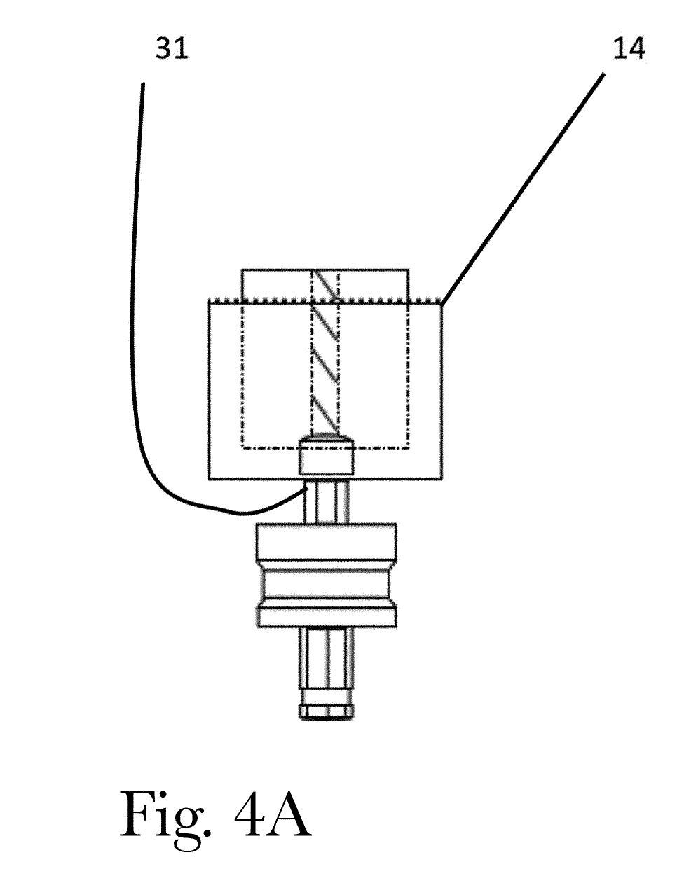

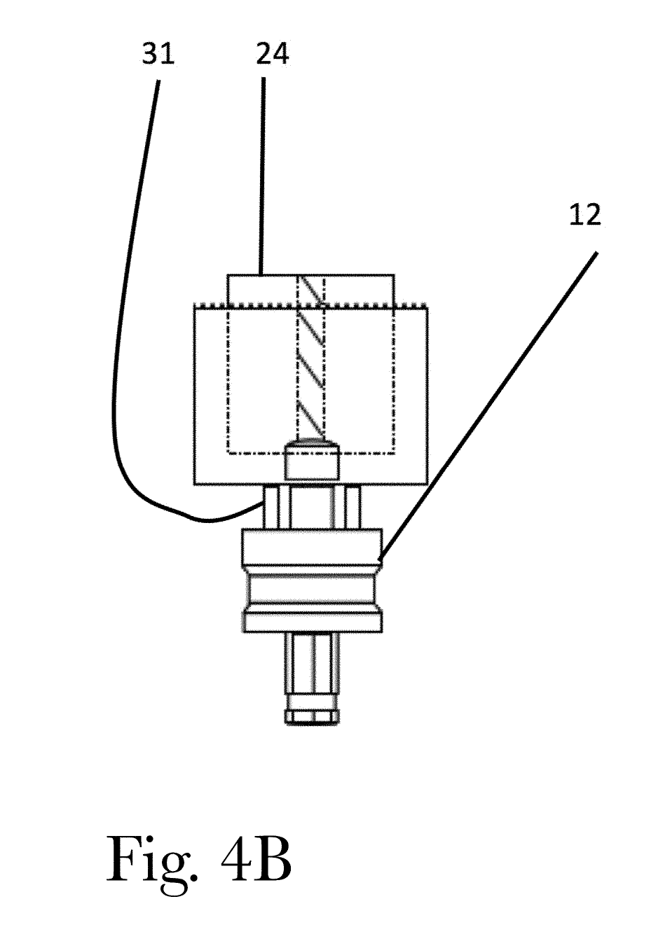

In use, a boss is fitted with a hole saw element 14, with the threaded element 28 of the boss being screw-threadingly inserted through the bore 27 of the hole saw element. Conveniently, the hole saw 14 is provided with two further diametrically opposite spaced apertures 29, through which spigots 31, as shown with reference to boss 12 in FIGS. 3A and 3B, which show, respectively perspective and side views of the boss, without further elements being associated therewith. The FIGS. 4A and 4B show the hole saw element 14 and guide element 24 being placed in alignment with the spigots 31, with the mandrel retracted in the second, unstable position (i.e. against the forces of the resilient element) in side view, being rotated approximately 90° one view with respect to the other. In the alternative, the mandrel may be biased against movement by way of a friction fit, so instead of the mandrel being retracted against a resilient member, the mandrel is urged towards the proximal end of the boss merely by overcoming the friction grip, as provided by a polymeric element against the boss, for example. In the alternative the mandrel may be provided with a friction element or a ball-detent locking system as is known in the art, and may have a detent locking in the engagement position only or in the engagement and retracted positions. In any event, the mandrel does not rotate with respect to the boss, so that when the hole saw has received the elongate element(s), the hole saw cannot rotate about the boss.

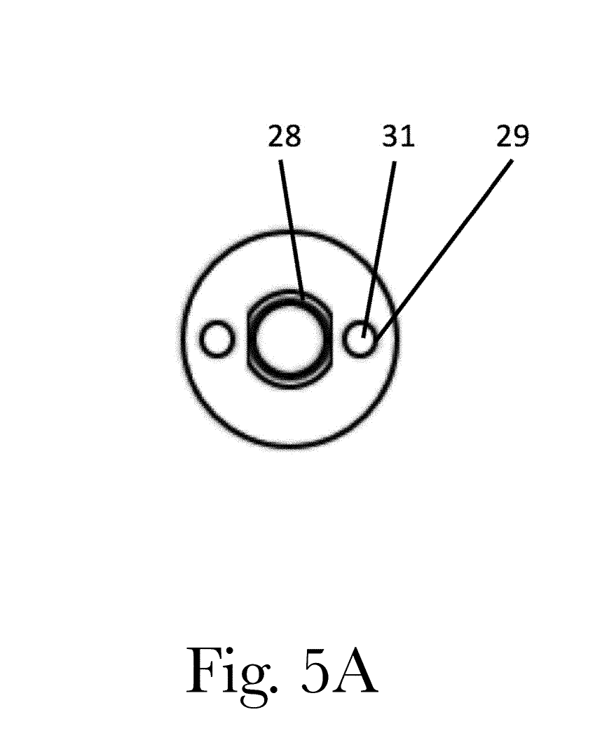

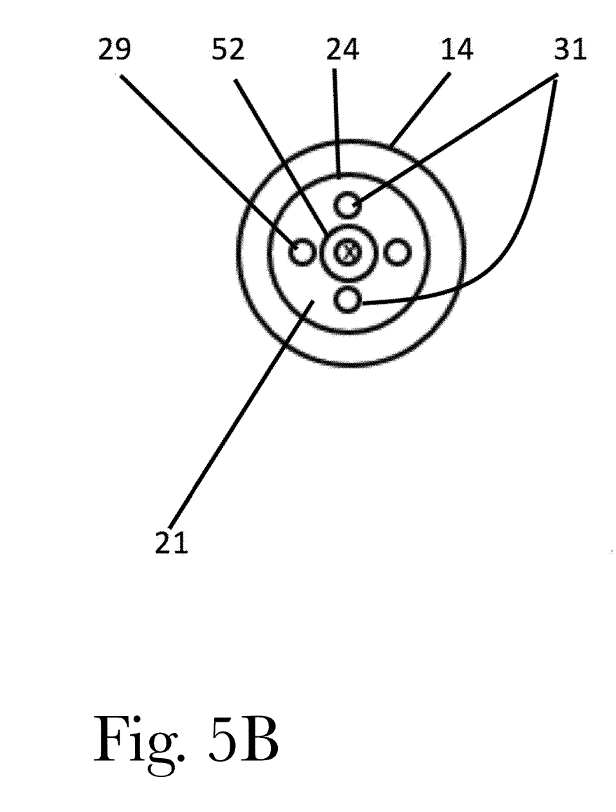

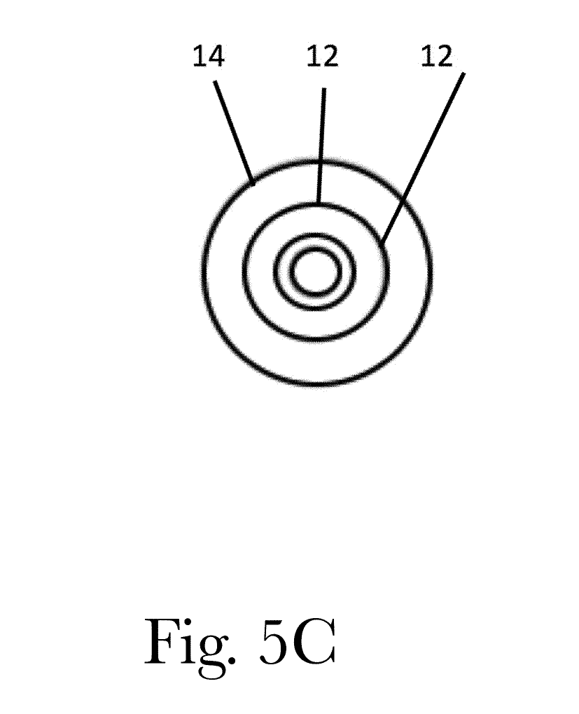

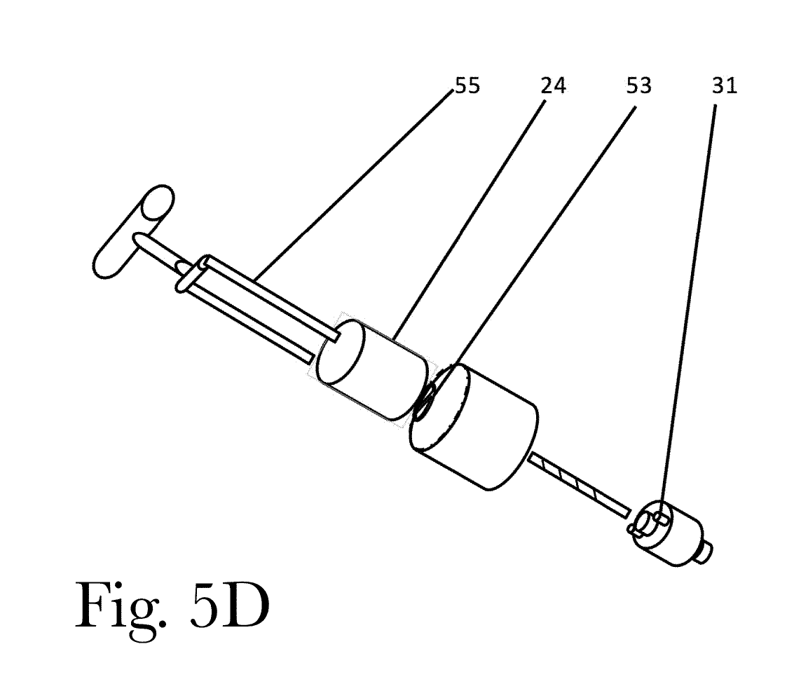

FIG. 5A shows a plan view of an inside of the hole saw 14 when seated against the mandrel upon boss, and the threaded element 28 is shown centrally extending through the central bore of the hole saw, with spigots 31 extending through the corresponding apertures 29 of the hole saw. FIG. 5B shows a plan view of a nested guide element 24 placed within the hole saw 14, together with drill bit 11: in this case two spigots 31 are upstanding from the base 21 of the guide element, the central bore 52 being provided with an internal thread, whereby the base 21 of the guide engages with the threaded element 28 of the boss, whereby to ensure that, in use, the hole saw does not rotate by slippage with respect to the boss. It will be appreciated that the boss may alternatively be provided with a threaded element with a flat axial wall, with the bore having corresponding dimensions to prevent slippage. When the threaded element 28 extends through a threaded bore 27, a tool 55 can extend within the guide element 24 to assist in placement of the guide, especially when the distal edge is provided with teeth as shown in FIG. 5D. In the alternative, if the inside floor of the guide element is provided with an upstanding hexagonal drive, having an internally threaded screw-thread are employed, then a suitable wrench can be employed with a corresponding hexagonal socket to fastened the assembly. A spacer 53 can be fitted, to ensure that they are easily separable. The guide element 24 is selected such that, in use, the diameter of the annular element corresponds in size to the pre-existing hole. FIG. 5C shows a distal view of the shaft 13, mandrel 12 and hole saw element 14.

In a further alternative, the guide element 24 can be provided with a bore having an internal screw-thread complementary to the external screw-thread of the threaded shaft 28, the guide element being provided with drive means such as hexagonal drive faces coaxially arranged about the bore upstanding from the base of the guide element, whereby a tool can engage with such hexagonal faces to allow the elements to be screw-fastened together. It will be appreciated that other fastening systems can be employed, although fastening systems including a screw associated with the guide element which can be directed towards the axis would need to be driven through a wall of the first and second coaxial walls whereby apertures though such members would need to be provided, which may act cause unwanted vibration through intermittent contact of the wall against the sides of the hole being created or the pre-existing hole.

In a still further embodiment, it has been found that the guide element can be provided in a plastics material, such as a polyamide-imide e.g. Torlon® which has considerable thermal stability. Such class of plastics have an extremely low coefficient of linear thermal expansion and provide excellent dimensional stability. Polyamide-imide plastics are known as amorphous materials with a Tg (glass transition temperature) of 537° F. (280° C.). Polyamide-imide plastics can be extruded or compression molded with glass-fiber reinforcement. Parts machined from Torlon® stock shapes provide greater compressive strength and higher impact resistance than most advanced engineering plastics and can therefore be provided as an alternative to tool steels for use in a guiding, non-cutting function. Indeed, engineering thermoplastic polymers are lighter and stronger than aluminum, magnesium alloy, aluminum alloy and other metals, so they offer a reduced weight advantage—which can assist in when operating hand-held tools. Indeed, there are other types of plastics materials, such as Acetal, which is actually a polyacetal of formaldehyde, with DuPont having a trade name of Delrin. This is an exemplary high density plastic that is considered as an aluminum substitute. Acetal is dimensionally stable, high tensile strength, wear resistant, and fairly impact resistant; it is commonly used to make bearings, pulleys, and wheels. It will be appreciated that it is necessary to have a guide, when made of such materials, to receive 6-10 turns of the thread within its tapped hole, to ensure that the screw-thread is not damaged in use; equally, if the material of the guide was similar to the hole saw, e.g. of a pressed steel, then in normal use, since the spigots do not extend beyond the threaded section of the boss, the guide will be secure after engagement, typically 2-6 turns, as it passes through metal of a thickness of typically of the order of 1.5-3 mm.

Another advantage in the use of engineering thermoplastics for replacement of metallic components is that they are simpler to produce; where die-casting and sheet metal construction techniques typically comprise a six-step process, thermoplastics can be transformed from granules to a finished part in a three-step process. Accordingly they can be cheaper to manufacture—and to replace if needed. More importantly, by having an engineering plastics with a degree of resilience, in the event that a tool is employed sufficiently off axis that the tool becomes jammed and, for example, the drill is left hanging within the aperture, then the tool is likely to resiliently give rather than become deformed, whereby any further use would mean that the guide would become unbalanced and therefore need to be replaced.

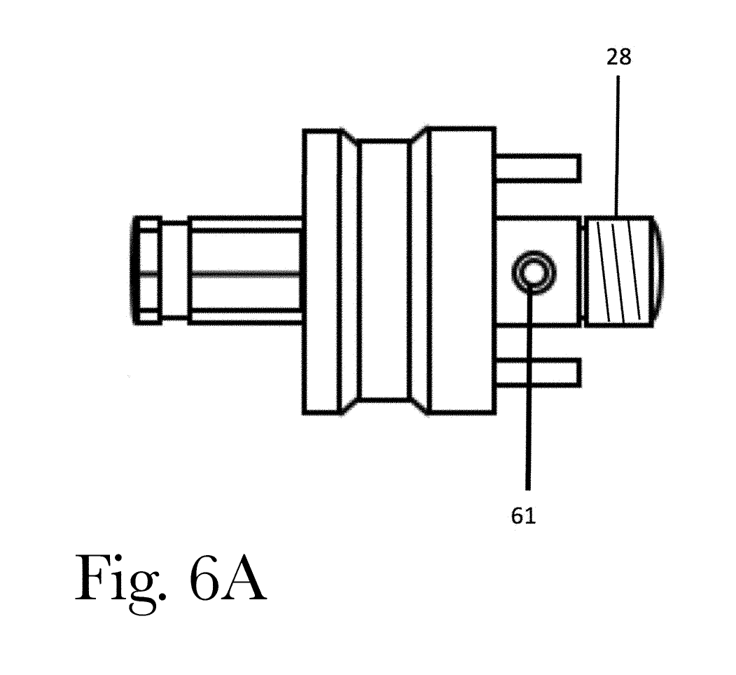

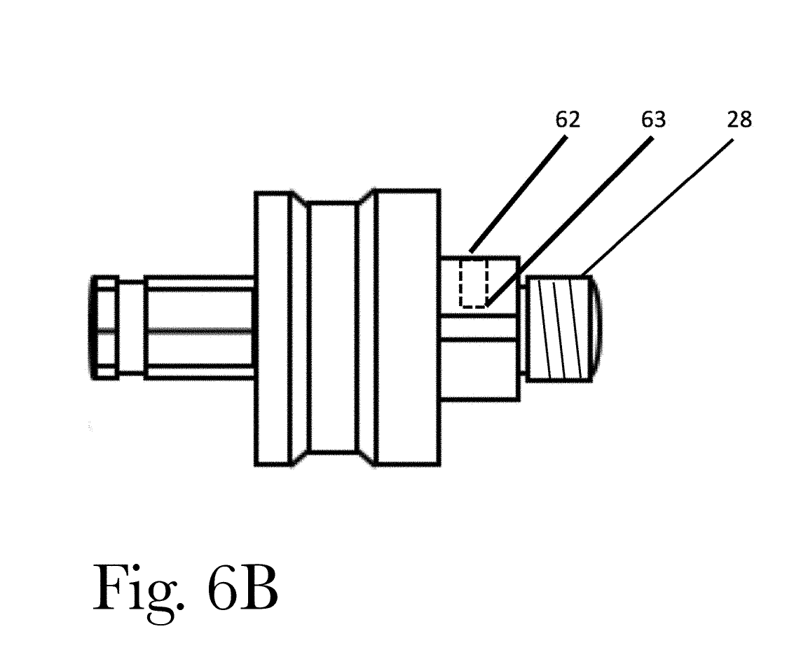

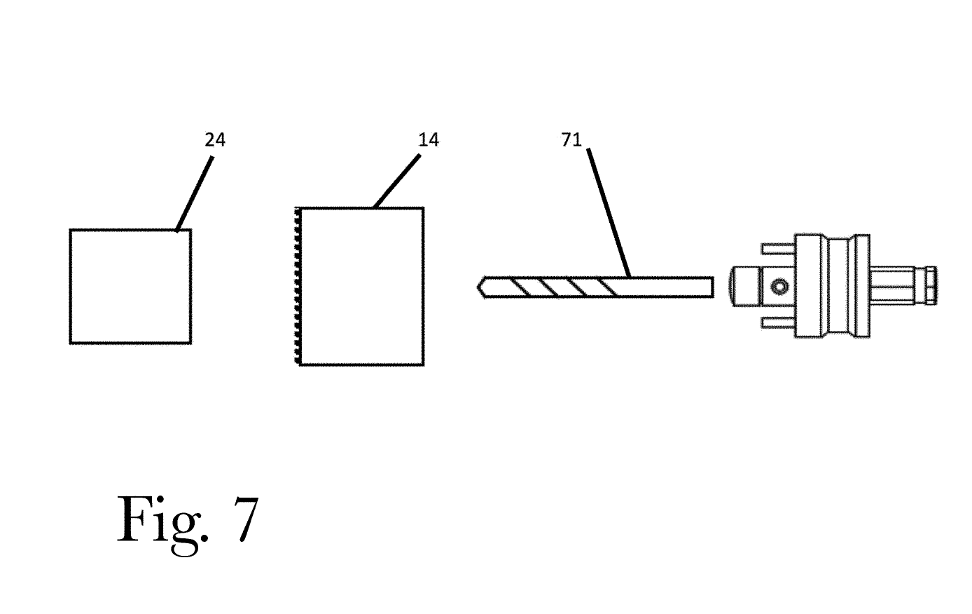

FIGS. 6A and 6B show side views of the mandrel 12 in a retracted position, with the axis horizontal, the two views showing the boss arranged approximately 90° rotated one with respect to the other. FIG. 6A shows a grub screw 61, which is inserted into passage 62 having a corresponding internal screw-thread, which leads into a channel 63 which opens out at a distal end of the threaded shaft 28. A distal end of the grub screw, in operation, acts against a surface of a shaft of a drill bit, as shown with reference to FIG. 7. It will be appreciated that a set of hole saws, together with guide elements in accordance with the invention may well be sold as a set with various sizes of hole saws and guide elements, although it is expected that a single central twist drill bit 71, having a shank diameter of dimensions to slide fit with respect to channel 63, which will be sufficient to cater for the events where there is no pre-existing hole.

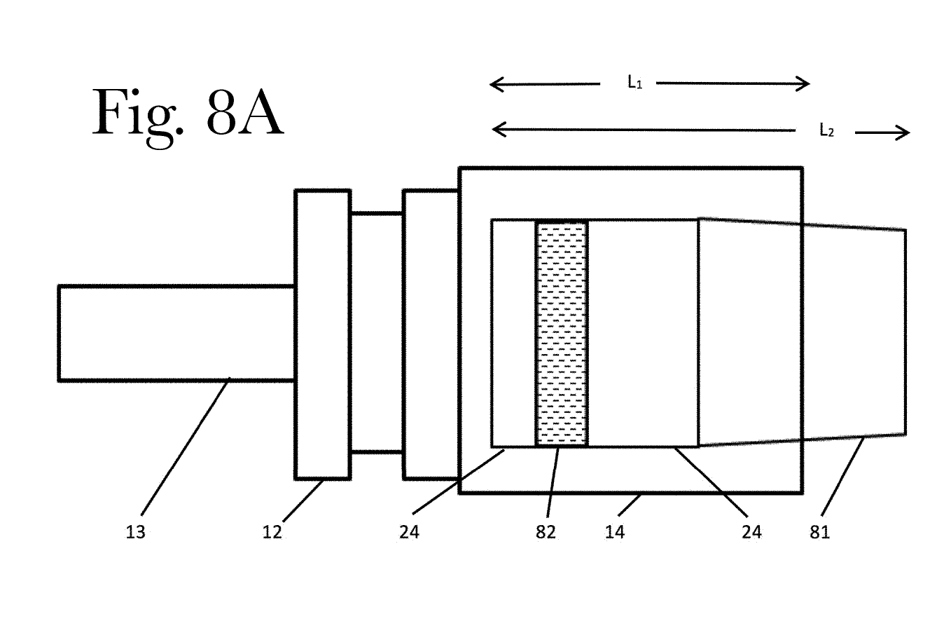

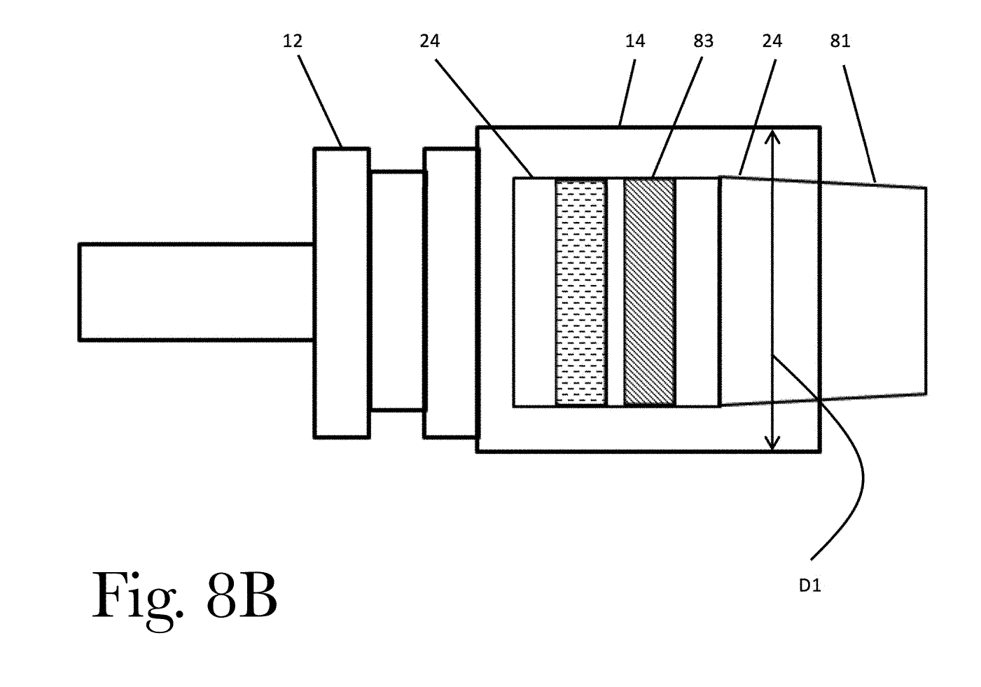

Referring now to FIG. 8A, it has been found that the guide element can be formed such that it defines a narrow angle frusto-conical element 81, such that the guide element engages with the annular element that is cut out from the work-piece, the frusto-conical element ensuring that the annular member does not fall out of hole saw element 14 and is contained within an interior diameter D1, the frusto-conical element being provided with a rotatable section 82, whereby the frusto-conical element remains stationary at its distal end, with respect to the annular member. FIG. 8B shows a further variation, the frusto-conical element being provided with a telescoping section 83, wherein the frusto-conical member 81 is both resiliently and telescopically mounted with respect to the base of the guide element. This enables the frusto-conical element to approach the boss as the cutting ensues, when the annular member cannot creep along the frusto-conical member and enables a greater depth to be achieved.

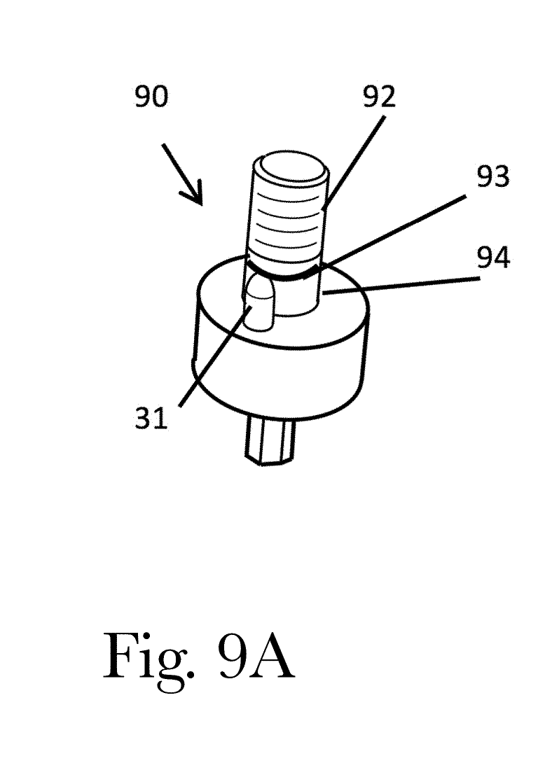

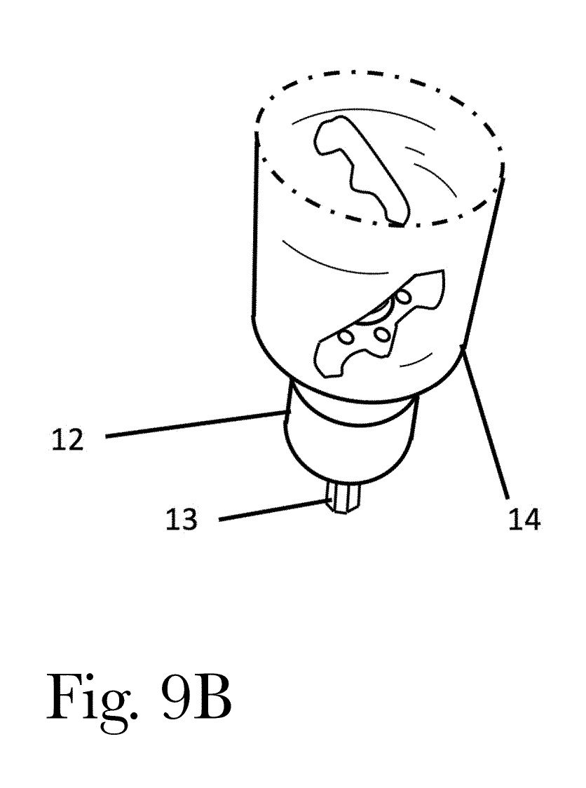

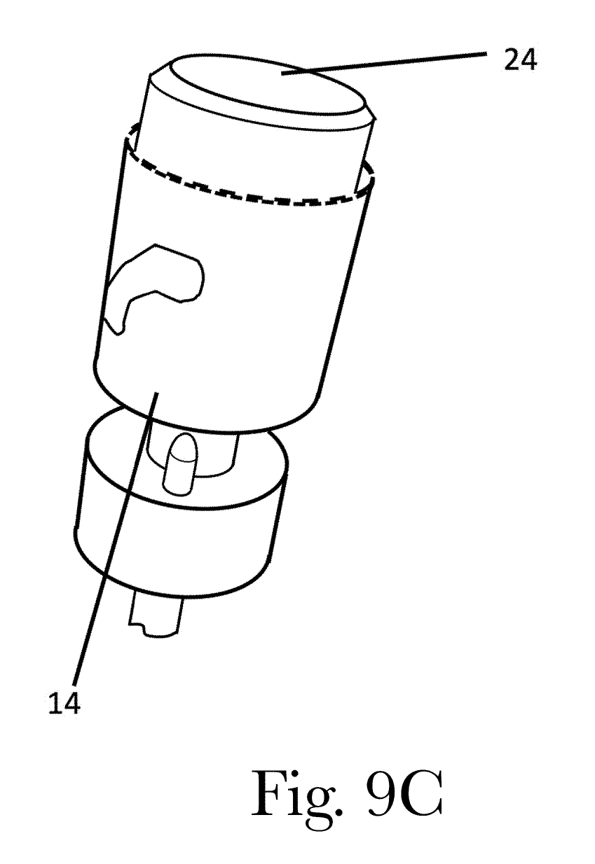

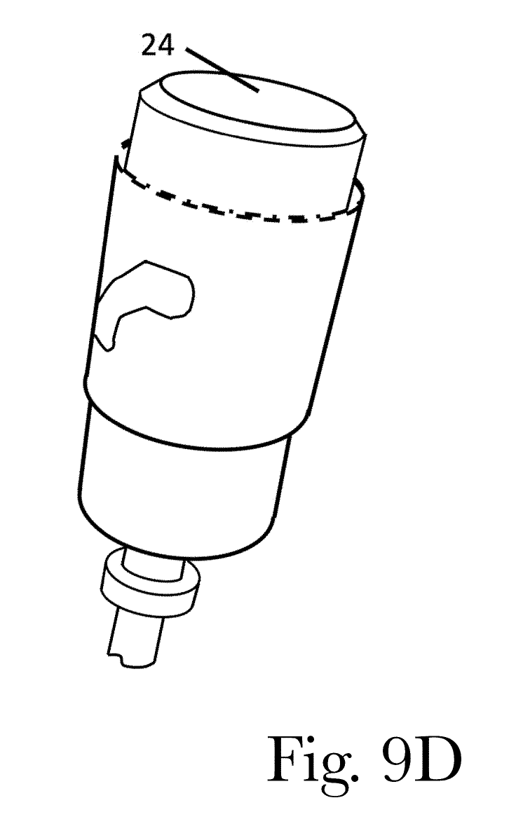

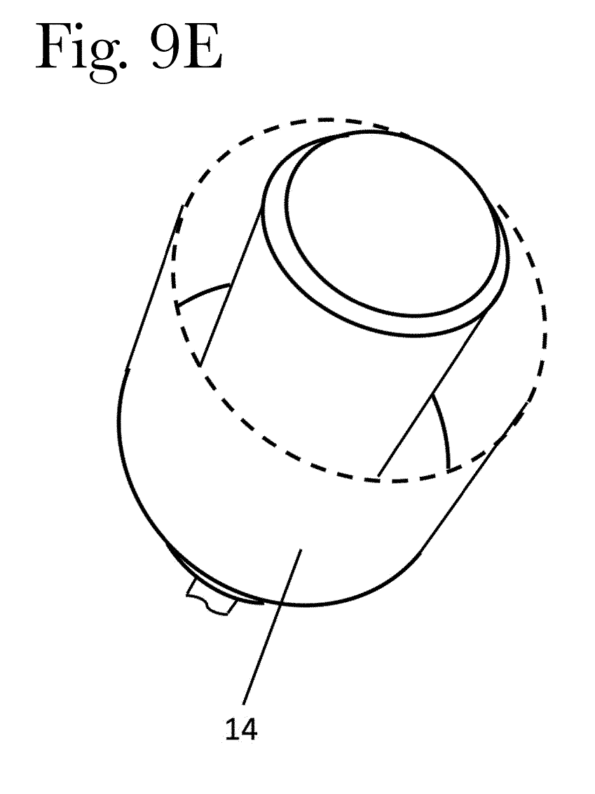

FIG. 9A shows a further embodiment of the invention wherein the boss 90 comprises a mandrel 12 that supports two engagement spigots 31. The boss is movably mounted upon shank 13 for engagement between a decoupled position (as shown), the shank 13 having a drive part of hexagonal section—for convenient coupling with a power tool—and an output section having a screw-threaded distal part 92 and an axial indent 93 on a plain shank portion 94, into which indent a resilient detent mechanism (not shown) associated with an inside surface of the bush can engage. In this embodiment, there is no central aperture for fitment of a central twist drill bit. FIG. 9B shows how hole saw member 14 can be screw-threadingly engaged with the screw-threaded distal part 92. This embodiment does not have an aperture for placement of a twist-drill bit for pilot drilling, where no pre-existing hole exists.

FIG. 9C shows how guide element 24 can be screw-threadingly engaged with respect to the screw-threaded distal part 92 of the shank 13. Boss 12 is in its decoupled position. In FIG. 9D, the boss 12 is shown in the second coupled position; the spigots 31 have been received within both the apertures 29 of the hole saw and the apertures 51 of the guide element. Detent means can be provided so as to enable axial alignment, if desired, although a simple visual check is otherwise all that is required. FIG. 9E shows a further perspective view of a guide element position within a hole saw assembly. It will be appreciated that there are several factors to be taken in to account in the design of the assembly. This embodiment, for example, does not have a central axial twist drill bit, which has been found to be more advantageous, in use, since the twist drill can remain in an operating configuration, irrespective of the presence if the guide element 24, which can be changed to suit a pre-existing hole or be removed where no pre-existing hole exists.

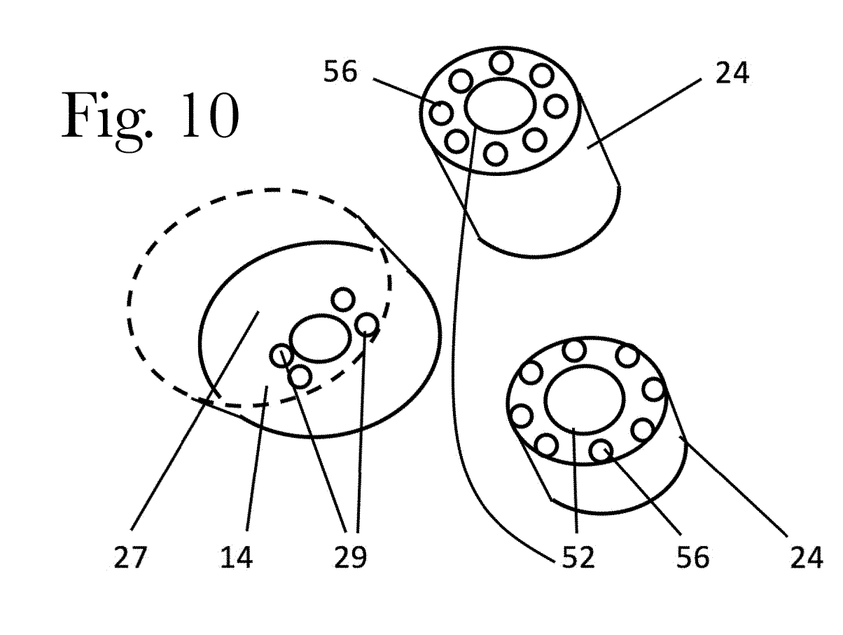

FIG. 10 shows a hole saw element 14 manufactured from tool steel and is provided with a central aperture 27 and alignment apertures 29 for association with spigots 31 of the mandrel 12, together with first and second guide elements 24. Each of these exemplary guide elements 24 is manufactured from Acetal and is provided with a central screw-threaded aperture 28 having apertures 56 radially arranged about the central aperture for association with spigots 31 of the mandrel 12. It has been found, in use, that tolerances of a few degrees of axial movement are permissible since once rotational movement has begun, the spigots act against an inside face of the hole saw and guide element apertures, 29, 56. When the guide element is manufactured from a plastics such as Acetal, it is prudent to have the threaded section 93 extend for at least a centimeter or so whereby over-tightening will not result in a stripping of the thread of the guide element. In the alternative, a threaded metallic bush element may be inserted in an aperture, whereby to provide a more rugged threaded element for the guide element. It should also be noted that the exemplary guide elements are shown as being solid cylinders; this is not mandatory; indeed it is beneficial for the guide elements to be machined or otherwise formed so that they do not represent a solid mass, which has implication in tool handling and can comprise an overall shape not dissimilar to a hole saw; a heavy guide element will be more difficult to manage in use.

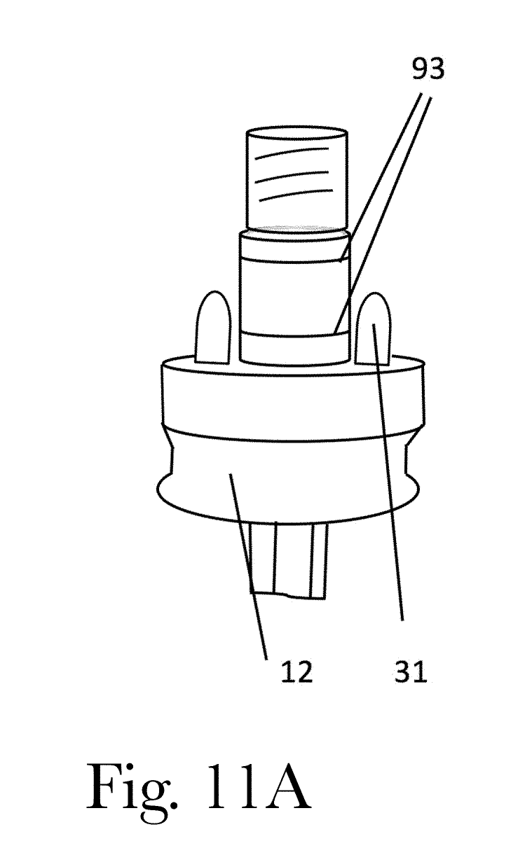

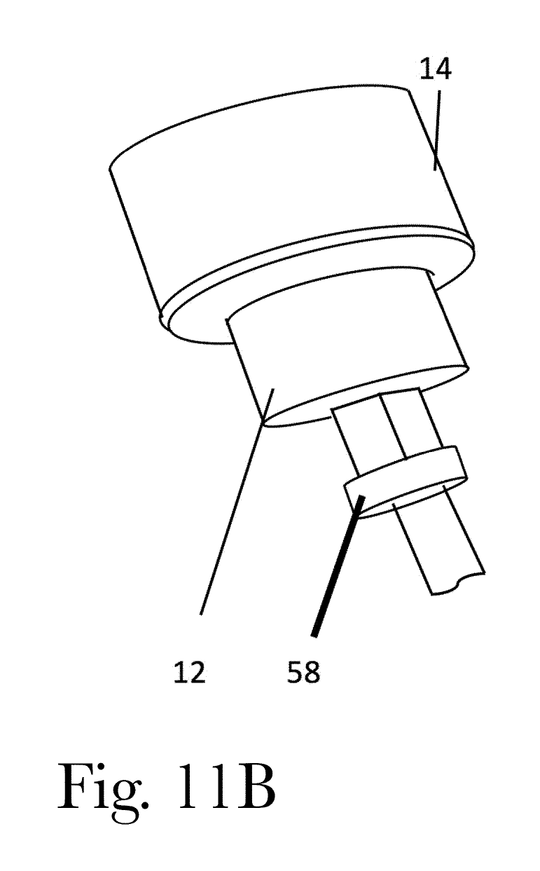

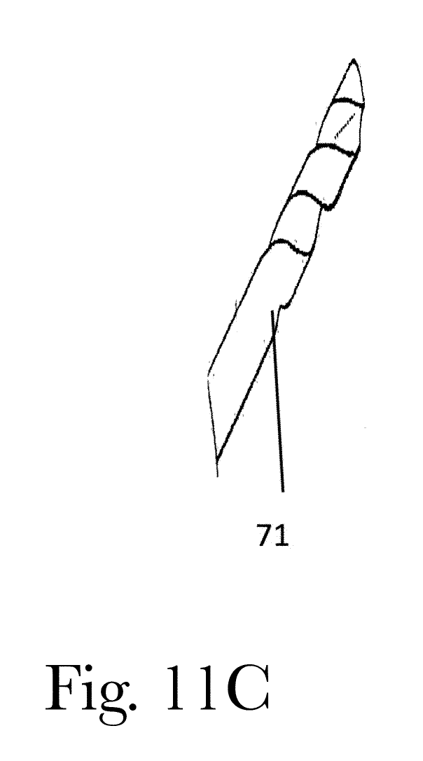

FIGS. 11A and 11B detail, respectively the boss—in a part-dismantled position, (where collar 58 per FIG. 11B is removed) wherein first and second annular indents 93 are shown on shank 94. FIG. 11B shows how the boss 12 abuts the base of hole saw 14 when in the second position. In an alternative, further embodiment, there is a twist-drill bit 71 protruding from the distal part 92 of the shank. FIG. 11C shows a boss with optional central drill bit 71 in position.

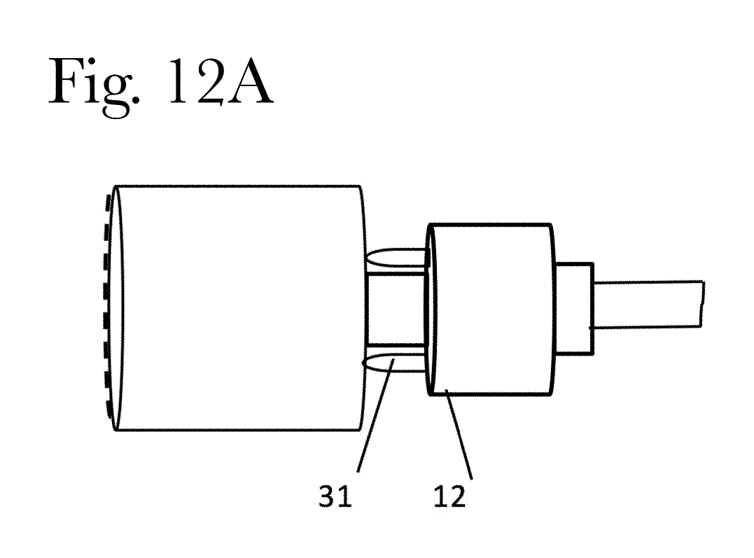

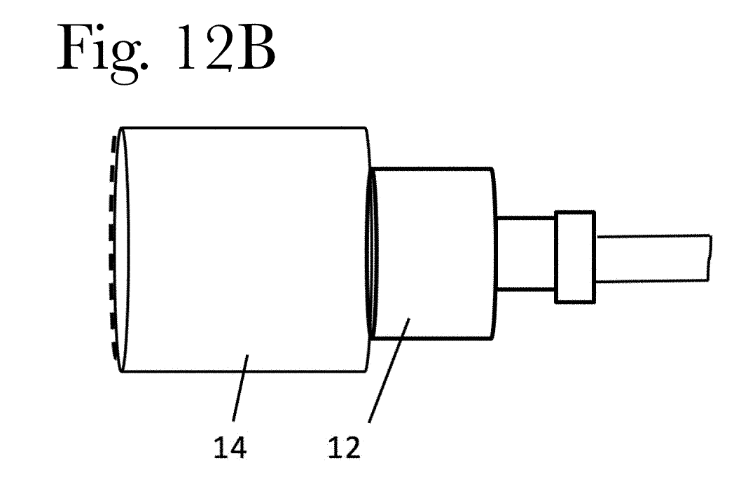

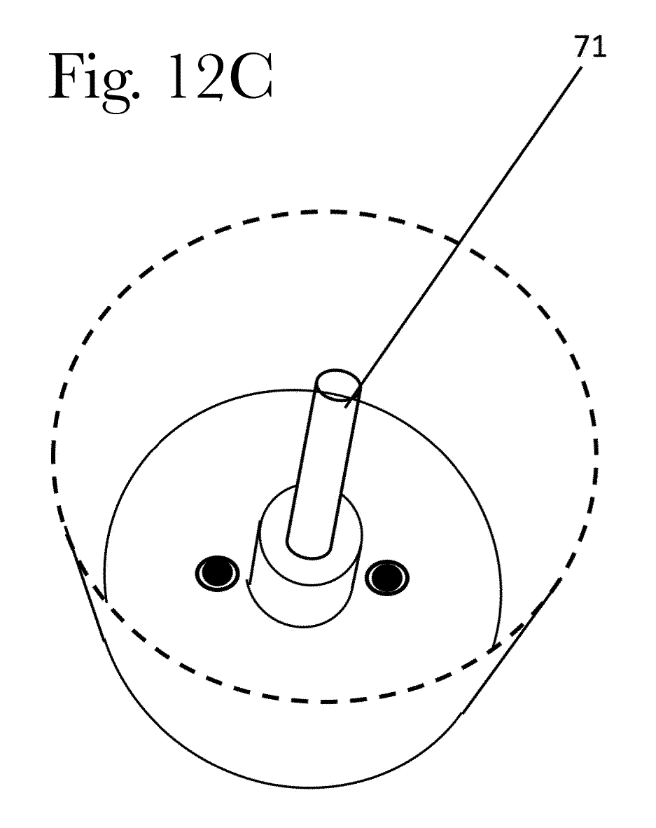

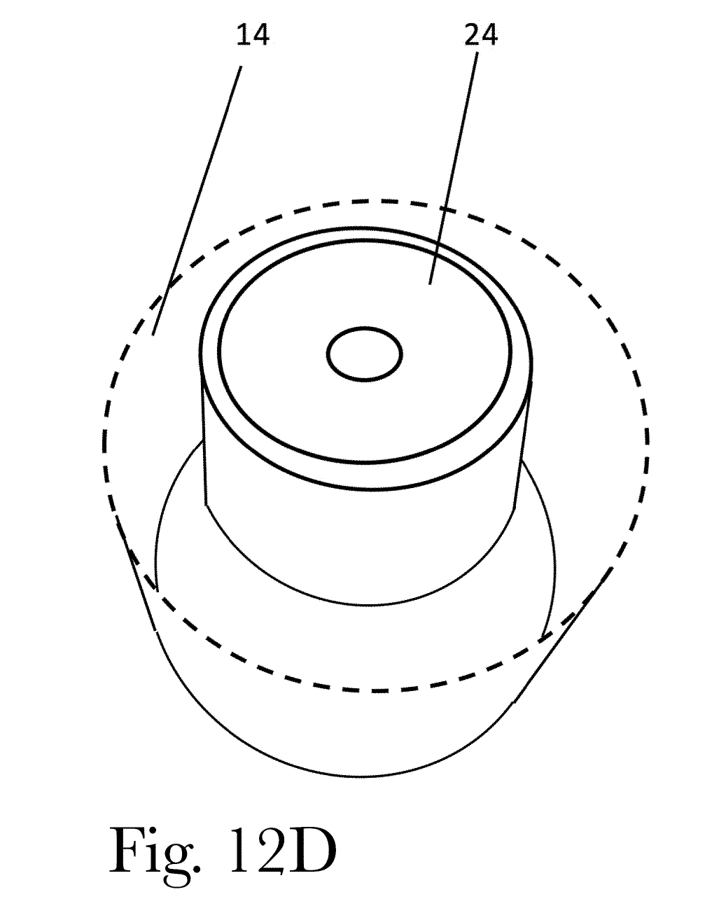

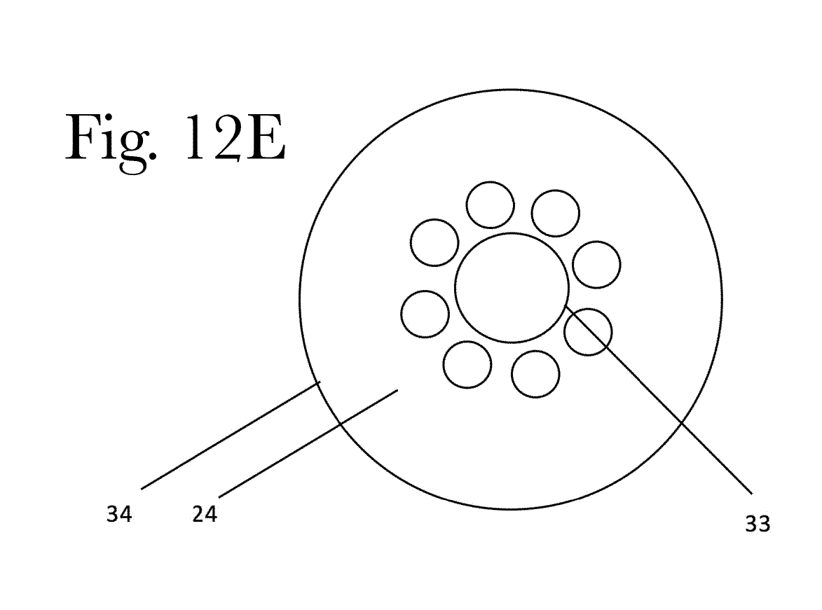

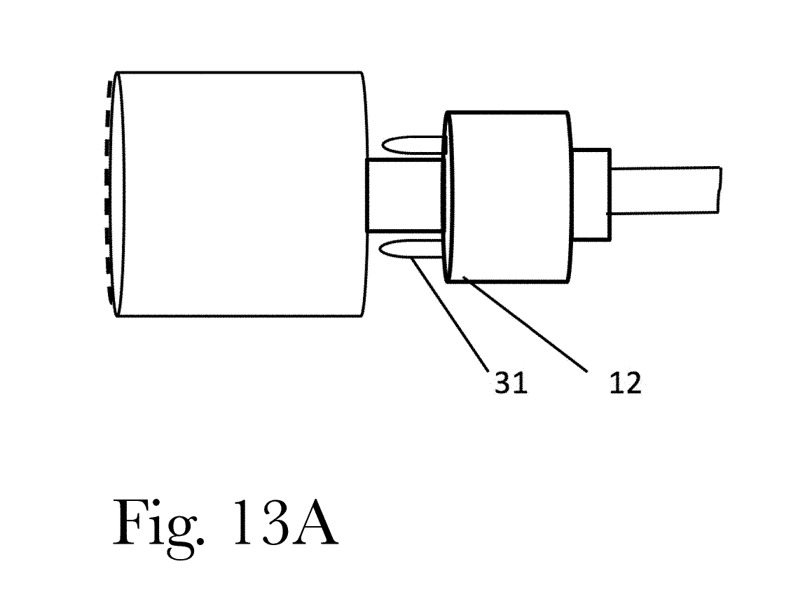

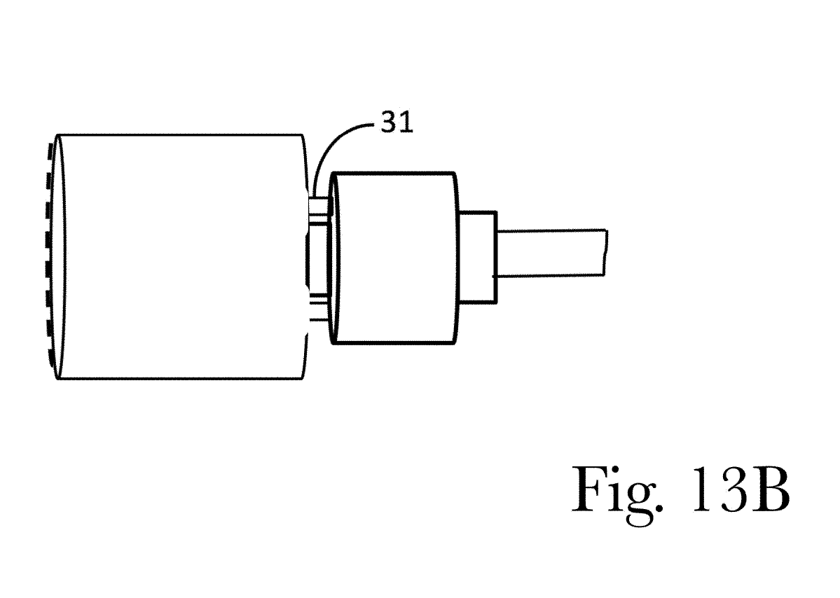

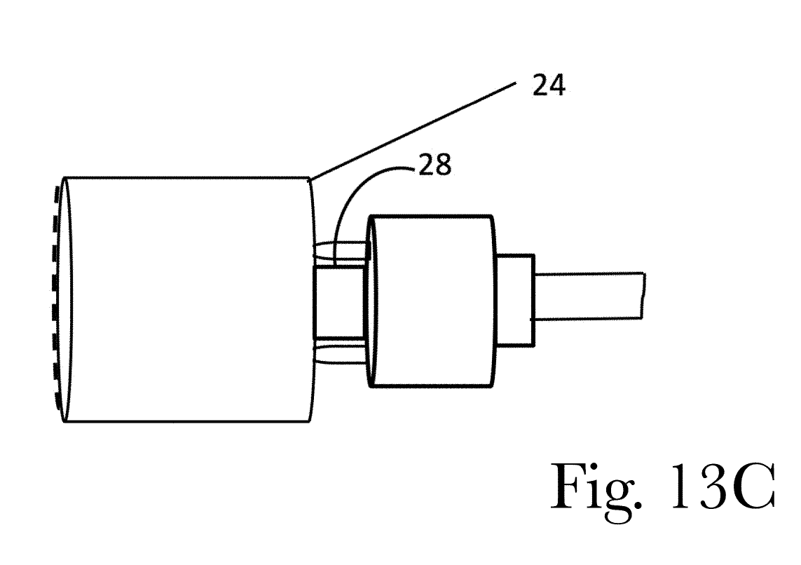

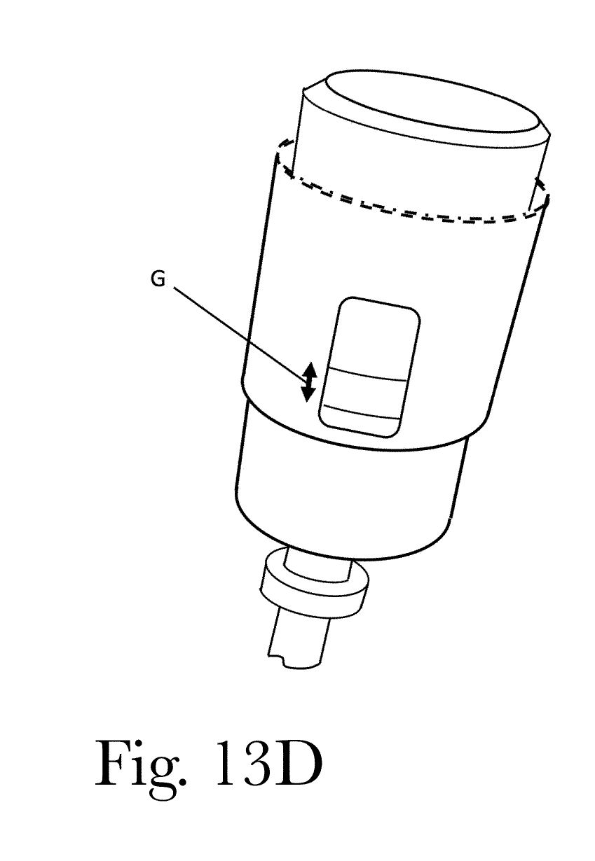

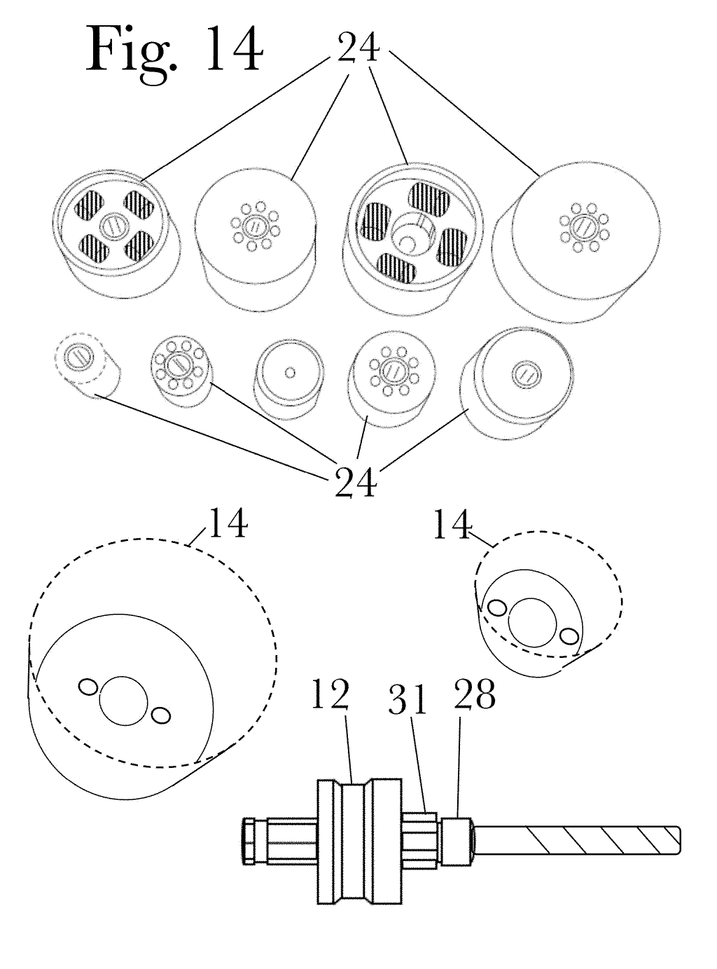

With reference to FIGS. 12A and 12B, the present invention is shown, respectively, with the mandrel in a first screw-thread-fastened yet non-spigot-engaged position and with the mandrel in a second screw-thread-fastened and radially-fastened spigot-engaged position. FIGS. 12C and 12D show the invention, respectively, with one and two hole saw elements, with the inner hole saw element of FIG. 12D acting as a guide element. FIG. 12E shows some holes 34 which are present in guide element 24 to reduce weight and rotating mass; the screw-thread 33 of the guide element being clearly shown. With reference to the following figures, the hole saw element is absent, to clearly show how guide element can be fastened; in FIG. 13A, the guide element is shown as being substantially fully screw-threadedly engaged with respect to the threaded shank 28, yet the mandrel is disengaged; in FIG. 13B, the mandrel is in an engaged position: in FIG. 13C, the guide element is not fully substantially screw-threadedly engaged with respect to the threaded shank 28, yet, surprisingly, is still secure—accordingly, the present invention provides a simple and reliable connection yet forgiving with regard complete engagement of the hole saw and guide member and, most importantly, providing a systems that, by way of spigot engagement elements prevents the mandrel/screw-threaded shaft, the hole saw and the guide elements from becoming screw-threadingly locked together, given that radial fixing of the parts is determined by the axially moving spigots. FIG. 13D, for example, shows how a hole saw, and guide element is securely fastened with respect to each other, both axially and radially, despite the gap “G” being present. FIG. 14 shows a simple range of sizes (non-limiting) of hole saw elements 14, guide elements 24 for a mandrel—boss assembly that can be provided for a workman which are easily and simply exchanged as between each other, depending upon the nature of an installation job.

Accordingly, the present invention provides a hole saw arrangement that enables the simple creation of holes, with a simple to operate hole saw change system and which enables pre-existing holes in plasterboard, cavity walls, block board and other wall/ceiling building divisional walls etc. to be enlarged with a tool comprising a hole saw and guide that can enable a pre-existing hole—of various effective diameters—to be enlarged with the same basic tool. Indeed, the invention, in a preferred embodiment can be employed to cut a pilot hole when the guide element is removed. It will be appreciated that simple alternatives are possible: for example, the may exist two elongate elements extending from the mandrel which locate through the base of the hole saw, yet only one extends though the base of the guide element, or that the elongate element engage external parts of the guide element. The screw-thread about the boss with which the hole saw and the guide member could be distinct for each element, but are conveniently the same, to simplify manufacture and use.

While particular embodiments of this invention have been shown in the drawings and described above, it will be apparent, that many changes may be made in the form, arrangement and positioning of the various elements of the combination. In consideration thereof, it should be understood that preferred embodiments of this invention disclosed herein are intended to be illustrative only and not intended to limit the scope of the invention.

What is claimed is:

1. A rotary hole saw for the creation of a hole in a work-piece, the tool comprising:
a generally cylindrical boss having a shaft at a proximal end for fitment to a chuck of a drill tool and rotation therewith about a central axis; and
a hole saw for cutting a substantially circular hole in a work-piece;
wherein the boss comprises a mandrel and a screw-threaded portion, wherein the mandrel is operable to axially slide between a proximal release position and a distal locking position, between the proximal end and the screw-threaded portion at a distal end of the boss, the mandrel having at least one elongate member extending in a distal direction coaxial with the central axis;
wherein the hole-saw element comprises a generally cup-shaped cutting element, having a base and a circularly cylindrical annular wall element extending therefrom with a distal edge at a distance L1 from the base, wherein the base has a central screw-threaded portion for coupling with the boss and at least one aperture through which the at least one elongate member of the mandrel can extend;
the mandrel having a bias to the distal locking position, such that once the hole saw is screw-threadedly associated with the boss and the mandrel faces the base of the hole saw and the at least one elongate member of the mandrel extends into the bases of the hole saw the boss and the hole saw become axially and radially fixed with respect to each other.

2. A rotary hole saw according to claim 1, operable for the enlargement of a pre-existing hole in a work-piece, the tool further comprising:
a guide element;
wherein the guide element has a base and a circularly cylindrical annular wall element, wherein the base of the guide element has a central screw-threaded portion for coupling with the boss and at least one aperture through which the at least one member of the mandrel can extend, the annular wall element having a distal edge arranged at a distance L2 from the boss, wherein in use, the guide element can be inserted into the pre-existing hole to provide support in centralizing the rotary saw therewith, the guide element extending a distance L2−L1, beyond the hole saw;
the mandrel having a bias to the distal locking position, such that when the hole saw and the guide are screw-threadedly associated with the boss, the mandrel faces the bases of the hole saw and the guide and the at least one elongate member of the mandrel extends into the bases of the hole saw and the guide whereby to axially and radially fix the same.

3. A rotary hole saw according to claim 1, wherein the mandrel is provided with elongate members, which locate and abut with respect to two apertures associated with the base of the of the hole saw and the base of any guide.

4. A rotary hole saw according to claim 3, wherein the mandrel abuts the base of the hole saw element, when axially and radially fixed with respect to the boss.

5. A rotary hole saw according to claim 4, wherein the mandrel is associated with the boss element about a substantially cylindrical section of the boss, the movement between mandrel and the boss being determined by at least one of friction, detent means and resilient biasing to the locked position.

6. A rotary hole saw according to claim 2, wherein the guide element is fabricated as a pressed steel element.

7. A rotary hole saw according to claim 2, wherein the guide element is a generally cup-shaped element and a distal edge of the guide element is serrated.

8. A rotary hole saw according to claim 2, wherein the base of the guide has a screw-threaded portion for screw-threaded coupling with the boss fastened to the boss and having an annular wall element, the outside wall surface being generally smooth.

9. A rotary hole saw according to claim 2, wherein the guide element is fabricated from an engineering plastics material, as one of a molded or machined element.

10. A rotary hole saw according to claim 9, wherein the guide element is manufactured form a plastics material and has a centrally placed metallic insert having an internal screw-thread.

11. A rotary hole saw according to claim 1, wherein the distal end of the boss is provided with an aperture for placement of a guide drill bit.

12. A rotary hole saw according to claim 10, wherein with respect to the aperture placement of a guide drill bit, there is provided a radially directed internally threaded aperture and a screw-threaded member, whereby to enable securement of a drill bit therein.

13. A rotary hole saw according to claim 2, wherein a low friction paint is applied to an outside surface of the guide element.

14. A rotary hole saw according to claim 2, wherein the guide element has a slight frusto-conical shape, reducing in diameter at a distal end with respect to the boss.

15. A rotary hole saw according to claim 2, wherein a distal portion of the guide element is mounted for rotation with respect to the base of the guide element.

16. A rotary hole saw according to claim 2, wherein a distal portion of the guide element is resiliently and telescopically mounted with respect to the base, whereby the distance L2 can decrease in the event further axial progress by the guide element is prevented.

17. A hole saw according to claim 2, wherein the guide element can be placed about a twist drill bit when fastened to the boss.

18. A hole saw according to claim 1, further comprising a twist drill element that can be operably fastened by a chuck element having a base, wherein the chuck element base has an internally threaded aperture and at least one aperture through which the at least one member of the mandrel can extend, whereby to secure the twist drill element in place of a guide element.
